(19) United States
(12) Patent Application Publication
(10) Pub. No.: US 2010/0054776 A1
(43) Pub. Date: Mar. 4, 2010

(54) IMAGE FORMING APPARATUS

(75) Inventors: Yoshihiro Mitsui, Numazu-shi (JP); Shinichi Agata, Suntou-gun (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/549,246

(22) Filed: Aug. 27, 2009

(30) Foreign Application Priority Data
Aug. 29, 2008 (JP) 2008-221133
Jul. 3, 2009 (JP) 2009-158617

(51) Int. Cl. G03G 15/02

(52) U.S. Cl. 399/50

(57) ABSTRACT

An image forming apparatus includes an image bearing member and a charging roller rotatable in contact therewith. Before driving of the image bearing member starts, a bias having the same polarity as that of an image forming bias is applied between the charging roller and the image bearing member. The time of application of the bias varies with the accumulated time of rotation of the image bearing member or the time of making the driving of the image bearing member inactive.

### BACKGROUND OF THE INVENTION

1. Field of the Invention

The present invention relates to an image forming apparatus that forms a latent image on an image bearing member by, for example, electrophotography or electrostatic recording, develops the latent image, and obtains a visible image.

2. Description of the Related Art

An image forming apparatus, such as an electrophotographic copier or an electrophotographic printer, often uses a charging member for uniformly charging the surface of an image bearing member. A commonly used example of the charging member is a charging roller rotated in contact with the image bearing member (hereinafter referred to as the photosensitive drum) so as to follow rotation of the image bearing member being driven. A typical image forming process performed in the photosensitive drum and its neighboring components in such an image forming apparatus can include the following processing: uniform charging of the surface of the photosensitive drum, formation of a latent image by exposure, making the latent image visible with toner using a developing roller, transferring of the visible image to an intermediate transfer belt and a medium, and recovery of toner remaining after transferring using a cleaning member.

During such a process, in particular in low-temperature environment, the toner remaining after transferring may escape from capture by the cleaning member and that toner may contaminate the charging roller. The contamination like this may hinder the charging roller from uniformly charging the surface of the photosensitive drum. This may lead to unevenness in charging of the surface of the photosensitive drum and may result in a poor image quality.

One example of a technique aiming to prevent toner from contaminating a charging roller is disclosed in Japanese Patent Laid-Open No. 5-11569. According to this technique, a cleaning member specifically designed for a charging unit is made to come into contact with the charging roller, a unit for maintaining a potential difference containing an alternating voltage is disposed between the cleaning member and the charging roller, and the cleaning member is vibrated. Another example technique described in Japanese Patent Laid-Open No. 10-254223 aims to prevent unevenness in charging by detecting a current passing through a charging roller even if toner contamination occurs and changing a charging bias.

However, the image forming apparatus described in the first mentioned patent document needs to arrange a new member adjacent to the charging roller. The image forming apparatus described in the second mentioned patent document also needs a structure for detecting a current. Accordingly, both of them result in an increase in cost and size.

If contamination of the charging roller with toner locally occurs or a large amount of toner is attached, unevenness in charging causing an adverse effect on an image is present in the surface of the photosensitive drum. However, it is known that, if toner gradually contaminates the charging roller over its entire surface uniformly, the contamination does not exert a severe adverse effect on an image. In this case, the above-described approaches are considered to be unnecessary.

However, the results of a close study made by the inventors reveal that there is a case where, even if toner gradually contaminates the charging roller over its entire surface uniformly, an adverse effect on an image resulting from unevenness in charging caused by toner contamination of the charging roller is present. The adverse effect on an image can be an unnecessary transverse line appearing in the image in a cycle of the charging roller. The transverse line is caused by toner contamination transferred from the charging roller to the photosensitive drum at a contact nip portion of the charging roller and the photosensitive drum when driving of the photosensitive drum is inactive.

### SUMMARY OF THE INVENTION

The present invention provides an image forming apparatus capable of reducing an adverse effect shown in an image in a cycle of a charging roller resulting from contamination of the charging roller with toner.

According to an aspect of the present invention, an image forming apparatus includes a rotatable image bearing member on which a toner image is capable of being formed, a charging roller rotatable in contact with the image bearing member, and a controller configured to control a voltage applied to the charging roller. The controller is capable of applying a control bias to between the charging roller and the image bearing member before rotation of the image bearing member and the charging roller starts, the control bias having the same polarity as that of a bias applied in image forming. According to another aspect of the present invention, an image forming apparatus includes a rotatable image bearing member on which a toner image is capable of being formed, a charging roller rotatable in contact with the image bearing member, and a controller configured to apply a voltage to the charging roller such that unevenness of toner contamination on the charging roller is reduced before applying an image forming bias.

Further features of the present invention will become apparent from the following description of exemplary embodiments (with reference to the attached drawings).

### BRIEF DESCRIPTION OF THE DRAWINGS

FIG. 1 illustrates a schematic configuration of an image forming apparatus according to an embodiment of the present invention.

FIGS. 2A and 2B illustrate a portion of FIG. 1 and a process of transferring toner contamination between a charging roller and a drum.

FIG. 3 illustrates a process of operations of the image forming apparatus.

FIG. 4 is a graph that illustrates a relationship between a contamination returning bias and an adverse effect in an image (unnecessary transverse line in an image).

FIG. 5 is a sequence chart that illustrates timing of starting driving the drum and timing of application of a bias to the charging roller according to a first comparative example and a first embodiment.

FIG. 6 is a graph that illustrates an appropriate contamination returning bias with respect to time of making driving of the drum inactive using accumulated time of rotation of the drum as a parameter according to a third embodiment.

### DESCRIPTION OF THE EMBODIMENTS

Exemplary embodiments of the present invention are illustratively described below with reference to the drawings. It is noted that the dimensions, materials, shapes, and relative arrangement of components described in the embodiments are to be changed depending on the configuration of an apparatus to which the present invention is applied or various conditions and are not intended to limit the scope of the invention.

### (1) Overall Configuration of Exemplary Image Forming Apparatus

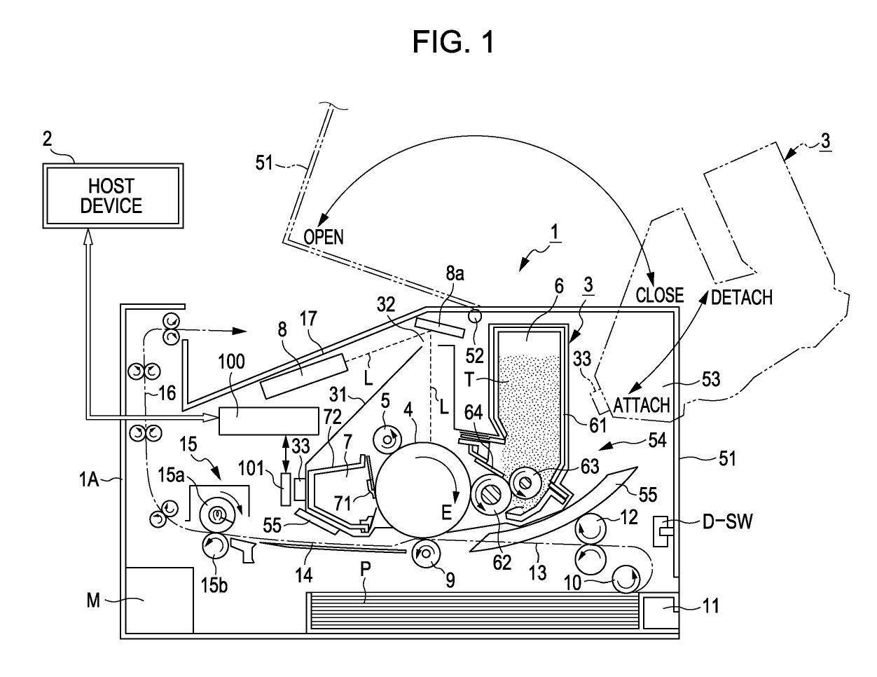

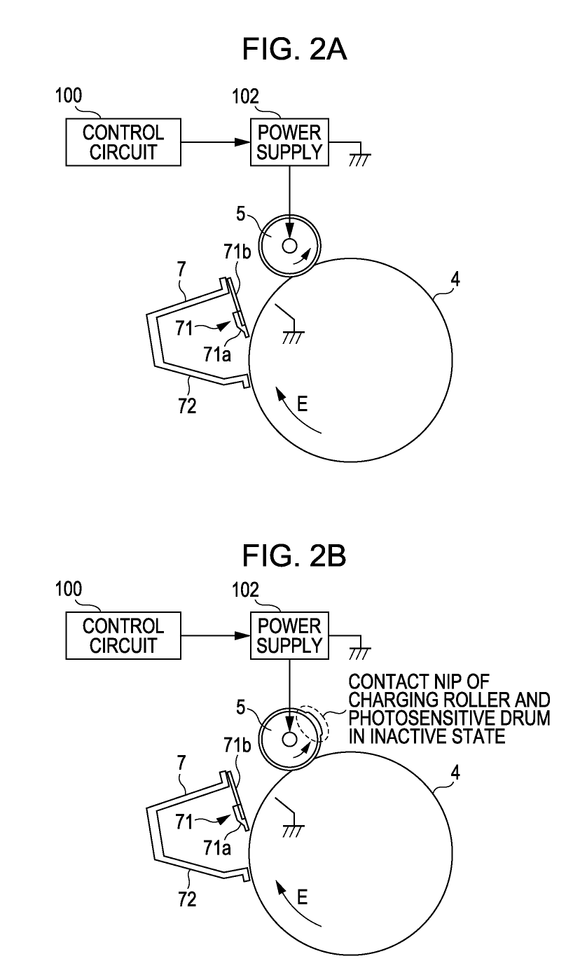

FIG. 1 schematically illustrates an image forming apparatus 1 according to a first embodiment. FIGS. 2A and 2B illustrate a portion of FIG. 1. The image forming apparatus 1 is a laser beam printer using an electrophotographic process and an attachable/detachable process cartridge. A control circuit (central processing unit (CPU)) 100 is connected to a host device 2 (e.g., a personal computer and an image reader) by the local area network (LAN). The image forming apparatus 1 performs an image forming operation on a recording medium P in response to electrical image information input from the host device 2 to the control circuit 100.

The image forming apparatus 1 includes a main body of a printer (hereinafter referred to as an apparatus main body) 1A. A process cartridge (hereinafter referred to as a cartridge) 3 is detachable from the apparatus main body 1A. In the following description, the lateral direction of the cartridge 3 is a direction in which the cartridge 3 is attached to and detached from the apparatus main body 1A. The longitudinal direction of the cartridge 3 is a direction substantially perpendicular to the direction in which the cartridge 3 is attachable to and detachable from the apparatus main body 1A. The front of the cartridge 3 is a surface (right-hand surface in FIG. 1) opposite to a surface of the leading end when the cartridge 3 is inserted into the apparatus main body 1A (left-hand surface in FIG. 1). The back of the cartridge 3 is an opposite surface to the front viewed from the front. The left and right of the cartridge 3 are the ones viewed from the front. The top of the cartridge 3 is an upper surface in a state where the cartridge 3 is attached in the apparatus main body 1A, and the bottom of the cartridge 3 is a lower surface in that state. The front of the image forming apparatus 1 is a side where a cover 51 is disposed. The left and right of the image forming apparatus 1 are the ones viewed from the front. The apparatus main body 1A is a part of the image forming apparatus other than the cartridge 3.

The cartridge 3 in the one in which an electrophotographic photosensitive member being a rotatable image bearing member on which a toner image can be formed and a process unit acting thereon are integrated into a cartridge. The cartridge 3 is attached to and detachable from the apparatus main body 1A. Examples of the process unit can include a charging unit, an exposing unit, a developing unit, and a cleaning unit. In the present embodiment, the cartridge 3 includes a cartridge frame 31 and an electrophotographic photosensitive member (hereinafter referred to as drum) 4 having a cylindrical (drum) shape. The drum 4 is rotatably held in the cartridge frame 31. As the process unit, a charging roller 5, a developing device 6, and a cleaning device 7 are supported. The charging roller 5 serves as a contact charging member being a charging unit configured to uniformly charge the drum 4. The developing device 6 serves as a developing unit configured to make an electrostatic latent image formed on the drum surface visible using a developer (hereinafter referred to as toner). The cleaning device 7 serves as a cleaning unit configured to remove toner remaining after transferring from the drum surface. That is, in the present embodiment, the cartridge 3 is the one in which the drum 4, the charging roller 5, the developing device 6, and the cleaning device 7 are integrated into a cartridge form so as to keep a predetermined relative positional relationship among them in the cartridge frame 31 such that the cartridge is attachable to and detachable from the apparatus main body 1A.

Opening the cover 51, which is positioned at the front of the apparatus main body 1A, about a hinge 52, as indicated by the chain double-dashed lines, to uncover the apparatus main body 1A allows the cartridge 3 to be attached and detached. When the cover 51 is opened, a cartridge attachment portion 54 inside the apparatus main body 1A can be seen from an opening 53 of the apparatus main body 1A. When viewed from the opening 53 formed when the cover 51 is opened, a leading-end descending guide 55 can be seen at each of the left and right walls of the cartridge attachment portion 54. The cartridge 3 is put into the cartridge attachment portion 54 such that the back of the cartridge 3 is in the leading end position while the front of the cartridge 3 is grasped by a user. Then, the cartridge 3 is sufficiently inserted along the guides 55 while the left and right sides of the cartridge 3 are supported by the respective guides 55. In such a way, the cartridge 3 is attached in a predetermined position within the apparatus main body 1A. In that predetermined attachment position, an exposure opening 32 in the upper part of the cartridge 3 faces a folding mirror 8a of a laser optical device (laser beam scanner; hereinafter referred to as a scanner) 8 serving as an exposure unit. The lower surface of the drum exposed below the lower surface of the cartridge 3 faces a transfer roller 9 serving as a contact transfer charging member (transfer unit) and is in contact therewith. In this state, the cover 51 is closed.

In a state where the cartridge 3 is attached in a predetermined position in the apparatus main body 1A and the cover 51 is closed, the cartridge 3 is mechanically and electrically connected to the apparatus main body 1A. At this time, a driven member of the cartridge 3 is drivable by a driving mechanism of the apparatus main body 1A. Also, sensors of the cartridge 3 can be conductive with the control circuit 100 of the apparatus main body 1A. The power supply of the apparatus main body 1A can apply a predetermined bias to the charging roller and developing roller of the cartridge 3.

The cartridge 3 includes a storage unit 33. Any form can be used as the storage unit 33. Examples of the storage unit 33 can include a contact non-volatile memory, a non-contact non-volatile memory, and a volatile memory having a power supply. In the present embodiment, a non-contact non-volatile memory is mounted as the storage unit 33 on the cartridge 3. The storage unit 33 has an antenna (not shown) being an information transmission unit for use in the storage unit 33 and wirelessly communicates with a main-body information transmission unit 101 included in the apparatus main body 1A. In a state where the cartridge 3 is attached in a predetermined position in the apparatus main body 1A, the storage unit 33 faces the main-body information transmission unit 101 in a predetermined position. In this manner, the control circuit 100 and the storage unit 33 can exchange electrical information (read and write information) therebetween. In the present embodiment, the control circuit 100 includes a control section, a calculating section, a storage section (read-only memory (ROM)), and a time function section. The control circuit 100 further has the function of reading information from and writing information in the storage unit 33 through the main-body information transmission unit 101. In the present embodiment, the storage unit 33 stores at least information on the number of sheets of image forming (printing) and information on the accumulated time of rotation of the drum 4.

The cartridge 3 can be detached from the apparatus main body 1A in the reverse way to the attachment procedure. In FIG. 1, when the cover 51 is opened and the cartridge 3 is pulled toward an upper right direction, the cartridge 3 is guided by the above-described guides 55 to outside the apparatus main body 1A.

An example image forming operation is described below. The control circuit 100 activates a drive motor (main motor) M in response to a print start signal. The activation of the drive motor M drives the drum 4 such that the drum 4 rotates in a predetermined speed (process speed) in a clockwise direction, as indicated by the arrow E. The surface of the drum 4 being driven so as to rotate is uniformly charged by the charging roller 5 to a predetermined polarity and a predetermined potential. The charging roller 5 is the one in which the outer surface of core metal is covered in rolls with a conductive elastic-body layer. The charging roller 5 is arranged substantially in parallel with the drum 4 while the both ends of the core metal are rotatably supported. The charging roller 5 is in contact with the surface of the drum 4 with a predetermined pressing force and is rotated so as to follow rotation of the drum 4. In the present embodiment, a power supply 102 applies a direct-current voltage of approximately −1,000 V as an image forming bias to the charging roller 5, and the surface of the drum 4 is uniformly charged at approximately −450 V. The potential of the drum 4 at this time is referred to as a dark-area potential Vd.

The control circuit 100 waits until the dark-area potential Vd is stabilized and then performs a laser scan exposure for image information on the charge process surface of the drum 4 using the scanner 8. The laser scan exposure forms an electrostatic latent image corresponding to the image information on the surface of the drum 4. The scanner 8 includes a semiconductor laser, a polygonal mirror, and an fθ lens. The scanner 8 outputs a laser beam L modulated (on/off converted) in accordance with a time series electrical digital pixel signal of the image information input from the host device 2 into the control circuit 100. The laser beam L enters the cartridge 3 through the exposure opening 32, and the drum surface is scanned and exposed with the laser beam L. The potential of the drum surface section (exposure light area) irradiated with the laser beam decays to approximately −100 V. This potential is referred to as a light-area potential Vl. The potential contrast between the above-described dark-area potential Vd and the light-area potential Vl forms the electrostatic latent image.

The electrostatic latent image formed on the drum 4 is reversely developed by the developing device 6 using, in the present embodiment, negative toner having a negative charging polarity. In the present embodiment, the developing device 6 is a reversely developing device using a non-magnetic one-component developer. Toner T being the developer is held in a developer container 61. A developing roller 62 being a developer bearing member is rotatably arranged in an opening of the developer container 61 opposing the drum 4. A supply roller 63 serving as a developer supplying member for supplying the toner T to the developing roller 62 while rotating in contact with the developing roller 62 is arranged in the developer container 61. A developing blade 64 serving as a developer regulation member for adjusting the toner T supplied to the developing roller 62 while a first end of the developing blade 64 is in contact with the developing roller 62 is also arranged. In this way, the developing device 6 applies the toner T to the drum surface, the toner T is attached to the region of the light-area potential Vl of the drum surface, and the electrostatic latent image is developed as a toner image.

The control circuit 100 drives a feeding roller 10 with predetermined control timing such that the feeding roller 10 rotates. This driving separates a single recoding medium P from recording media stacked in a cassette 11 and feeds the recording medium P. The recording medium P passes along a sheet path 13 through a pair of registration rollers 12 and is introduced into a transfer nip portion being a contact portion of the drum 4 and the transfer roller 9 with predetermined control timing. The on and off states of the rotation of the pair of registration rollers 12 are controlled with predetermined control timing. In a rotation off state, the pair of registration rollers 12 receives and temporarily stops the leading end of the recording medium P and corrects skewing of the recording medium P. The recording medium P is introduced into the transfer nip portion by the rotation of the pair of registration rollers 12 being switched on with predetermined control timing. That is, the recording medium P is transmitted by the pair of registration rollers 12 to the transfer nip portion in synchronization with the toner image on the drum 4. In a process in which the recording medium P is pinched by the transfer nip portion and conveyed therethrough, a transfer bias having a predetermined potential and an opposite polarity to the charging polarity of the toner (in the present embodiment, the opposite polarity is positive) is applied from a transfer bias power supply (not shown) to the transfer roller 9. In this way, the toner image on the surface of the drum 4 is continuously transferred electrostatically to the surface of the recording medium P.

The recording medium P exiting from the transfer nip portion is separated from the surface of the drum 4, passes along a sheet path 14, and is introduced into a fixing device (fixing unit) 15. The recording medium P introduced into the fixing device 15 is pinched by a fixing nip portion being a pressing contact portion of a fixing roller 15a and a pressure roller 15b and conveyed therethrough. In this pinched and conveyed process, the recording medium P is heated and pressed, an unfixed toner image is fixed as a fixed image on the surface of the recording medium P. The recording medium P passes along a sheet path 16 through a pair of conveying rollers and is ejected to a discharge tray 17 outside the apparatus.

After the recording medium P is separated from the drum 4, residues, such as toner remaining after transferring, are removed from the surface of the drum 4 by a cleaning blade 71 of the cleaning device 7, and the cleaned surface can be repeatedly used for image formation. The toner remaining after transferring and other residues removed from the drum surface by the cleaning blade 71 are received in a waste-toner container 72.

The cleaning blade 71 is arranged in an opposite direction to the drum rotation direction to achieve high cleaning performance. The cleaning blade 71 is in contact with a predetermined region of the drum 4 and forms a nip portion therewith. The cleaning blade 71 removes residues, such as toner remaining after transferring, by wiping the surface of the rotating drum 4 and scraping the residues off the drum 4. The cleaning blade 71 includes a support sheet metal 71b and a rubber blade 71a, as illustrated in FIGS. 2A and 2B.

### (2) Operation Sequence of Image Forming Apparatus

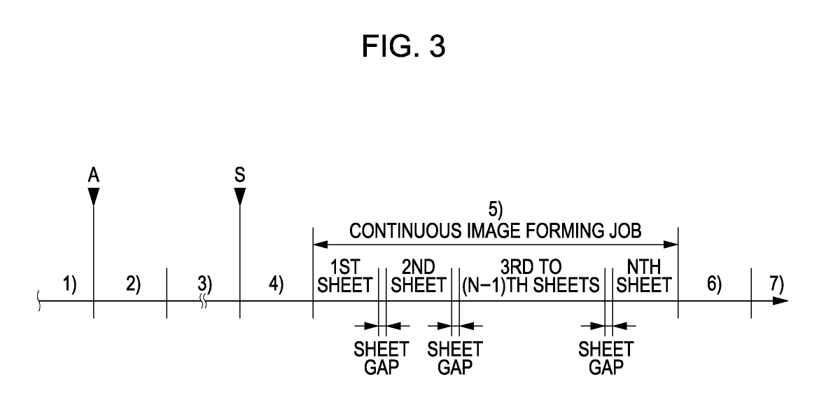

FIG. 3 illustrates a process of operations of the image forming apparatus.

### 1) Inactive State

When the power supply of the image forming apparatus is in an off state, that is, when a main power switch M-SW (not shown) is in an off state or when the cover 51 is opened and a door switch D-SW is an off state, the power supply circuit (not shown) is open and the image forming apparatus is kept in an inactive state.

### 2) Previous Multiple-Rotation Operation

The previous multiple-rotation operation is a starting operation (activation operation) performed when the power is turned on to the image forming apparatus. That is, this is an operation of, when the power is turned on, activating the drive motor M, driving the drum 4, and warming up a predetermined process device.

One example of the turning-on of the power to the image forming apparatus is switching the main power switch M-SW from an off state to an on state when the door switch D-SW is in an on state (the cover 51 is closed). Alternatively, another example thereof is switching the door switch D-SW from an off state (the cover 51 is open) to an on state (the cover 51 is closed) when the main-power switch M-SW is in an on state. In either case, the power supply circuit becomes closed (the power is turned on), and the image forming apparatus is kept in an active state.

The previous multiple-rotation operation is a preparatory operation for enabling the image forming apparatus to stably form an image. For example, in this operation, the state of the cartridge 3 is sensed, and in response to the sensed state, charging, developing, and setting the transfer bias are controlled appropriately. Also, process control, such as uniformly applying a fixed charging bias to make the surface potential of the drum 4 uniform or emitting light for use in exposure, is performed. That is, the previous multiple-rotation operation is a sequence for preparing and adjusting various operations for shifting to a stand-by state in which printing is executable. The previous multiple-rotation operation is performed when the main power switch M-SW is switched from an off state to an on state, and also performed when the door switch D-SW is switched from an off state to an on state.

### 3) Stand-by

When the predetermined previous multiple-rotation operation is completed, then the driving of the drive motor M becomes inactive and the image forming apparatus is kept in a stand-by state until a print start signal (image forming start signal) S is input.

### 4) Previous Rotation Operation

In response to the input of the print start signal S, the drive motor M is driven again, and a predetermined previous image forming operation that includes driving the drum 4 such that the drum 4 rotates is performed.

More specifically, the operation is performed in the following order: a) the control circuit 100 receives the print start signal S, b) the image is unwrapped by a formatter (the unwrapping time varies depending on the amount of data of the image or the processing speed of the formatter), and c) the previous rotation operation starts.

If the print start signal S is input during the 2) previous multiple-rotation operation, which is described above, after the previous multiple-rotation operation, the 4) previous rotation operation is performed without the 3) stand-by.

### 5) Image Forming Operation

When the previous rotation operation is completed, subsequently, an image forming operation for a single sheet (monochrome printing) or that for a plurality of sheets (continuous image forming job; multiple printing) is performed, and a recording medium on which an image has been formed is output. The sheet gap in a continuous image forming job is an interval between the rear end of a single recording medium and the leading end of a next recording medium.

### 6) Subsequent Rotation Operation

The driving of the drive motor M continues for a predetermined period of time after an image forming operation for a predetermined single sheet or a predetermined plurality of sheets is completed, and a predetermined image forming ending operation including driving of the drum 4 such that the drum 4 rotates is performed.

### 7) Stand-by

When the subsequent rotation operation is completed, the driving of the drive motor M stops, and the image forming apparatus is kept in a stand-by state until a next print start signal S is input. When the next print start signal S is input, the state shifts to the 4) previous rotation operation.

### (3) Measures to Reduce Unnecessary Transverse Line in Image

Next, measures to reduce a transverse line in an image carried out by the image forming apparatus according to the present embodiment are described below. The charging roller 5 is gradually contaminated by toner as image forming operation is performed again and again. However, it has been found that, when image formation operation is continuously performed again and again, an adverse effect caused by toner contamination of the charging roller 5 does not occur in an image.

The results of a close study made by the inventors reveal that there is a case where if the driving of the drum 4 becomes inactive and a halt period is provided, an unnecessary transverse line may occur in an image in a cycle of the charging roller in image forming immediately after the halt period.

A mechanism of the occurrence of the above-described unnecessary transverse line is described in detail with reference to FIGS. 2A and 2B. FIG. 2A is a schematic diagram that illustrates the drum 4 and the charging roller 5 when the image forming apparatus carries out continuous image forming of 5,000 sheets. The surface of the charging roller 5 has toner uniformly attached thereon. In this state, because the attached toner is uniform, there is no unevenness in charging, so an adverse effect does not occur in an image. However, it is found that, if the driving of the drum 4 becomes inactive and it is left to stand for a predetermined period of time, toner contaminating the charging roller 5 is transferred from the charging roller 5 to the drum 4 at the nip portion of the drum 4 and the charging roller 5. In this state, toner contamination on the charging roller 5 is uneven, so in a process of charging in image forming, charging unevenness periodically occurs in the circumferential direction of the drum, thus resulting in the occurrence of a transverse line in the image.

Here, the inventors have considered the possibility of reducing the above-described adverse effect in the image by returning the toner contamination transferred from the charging roller 5 to the drum 4 when the driving of the drum 4 is inactive, to the charging roller 5 before the drum 4 is driven again so as to rotate.

The results of a close study made reveal that it is useful to execute a contamination returning control mode in which a bias VA having the same polarity as that of a bias applied between the charging roller 5 and the drum 4 in image forming (image forming bias) is applied before the drum 4 is driven so as to rotate. More specifically, the absolute value of the contamination returning bias VA is equal to or larger than 200 V and smaller than a discharge starting voltage (the value of a voltage at which charging starts).

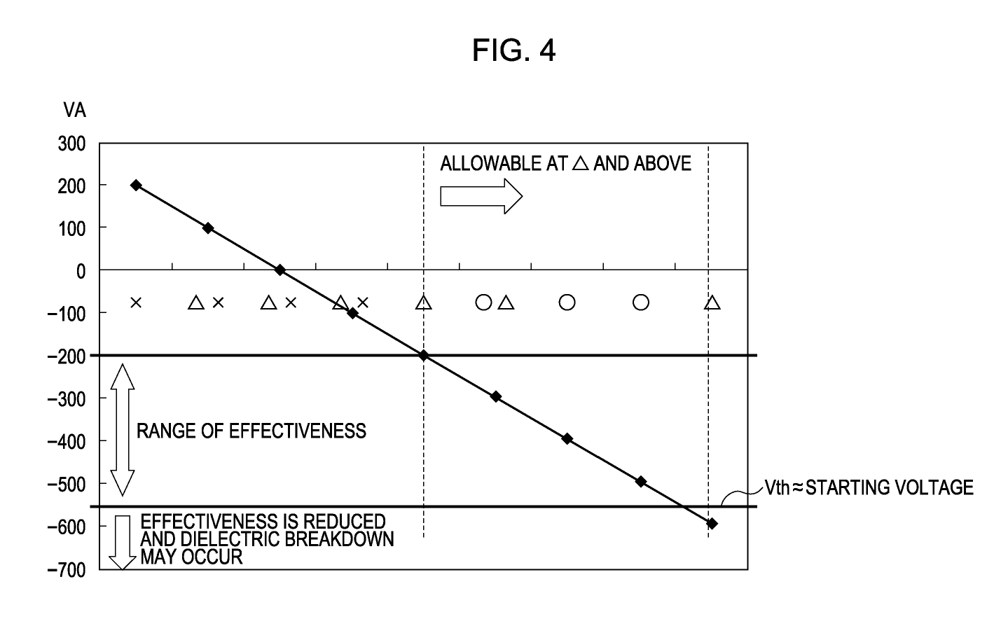

The results of the close study are illustrated in FIG. 4. In this study, the cartridge 3 after the image forming apparatus according to the present embodiment carried out continuous image forming of 5,000 sheets was used. After the driving of the drum 4 was inactive for approximately 120 minutes, before the driving of the drum started, the predetermined bias VA was applied to the charging roller 5 of the cartridge 3 in approximately 500 msec. After that, a normal image forming operation was carried out, the level of the occurrence of unnecessary transverse lines occurring in a cycle of the charging roller was observed using a halftone (HT) image with 25% density (more specifically, an HT image with 25% density in dithering of 150 lines/inch) at the first sheet.

In FIG. 4, the vertical axis indicates the values of the bias VA, and the horizontal axis indicates the image levels. In the image levels, x represents a bad level, Δ represents an allowable level, and ◯ represents a level at which no transverse line is observed. As illustrated in FIG. 4, when the applied bias VA is positive, which is opposite to the polarity of the image forming bias (the charging bias applied to the charging roller 5 in image forming), the level of the occurrence of unnecessary transverse lines deteriorates. When the applied bias VA is negative, which is the same polarity as that of the image formation, and has approximately −200 V, the level is allowable. As illustrated in FIG. 4, when the applied bias VA is in the range of −200 V to less than Vth (the value of a discharge starting voltage, which is referred to also as a starting voltage), there is a tendency for the level of the occurrence of transverse lines in an image to improve with an increase in the absolute value of the bias.

Here, Vth (starting voltage value) is the value of a charging bias when, in the case where the bias applied between the charging roller 5 and the drum 4 sequentially increases, the current caused by discharge starts being observed between the charging roller 5 and the drum 4 and the charging potential of the drum surface starts being observed. In the image forming apparatus according to the present embodiment, Vth is approximately 550 V.

When the applied bias is at or above Vth, as described above, because the discharge current flows, the potential difference between the charging roller 5 and the drum 4 cannot be ensured, an advantage of returning contamination to the charging roller 5 is decreased. The occurrence of discharging results in the discharge current locally flowing to the drum 4, so the possibility of an electrical breakdown of the drum 4 is increased.

As described above, the study reveals that a useful range of the value of the bias VA is equal to or larger than −200 V and is smaller than Vth.

Next, the present embodiment based on the results revealed by the above-described study is described below.

### First Comparative Example

in the image forming apparatus 1 according to the first embodiment, the bias VA is not applied before the driving of the drum 4 starts.

### First Embodiment

before the driving of the drum 4 starts, a bias of approximately −500 V is applied as the bias VA to the charging roller 5 for approximately 500 msec.

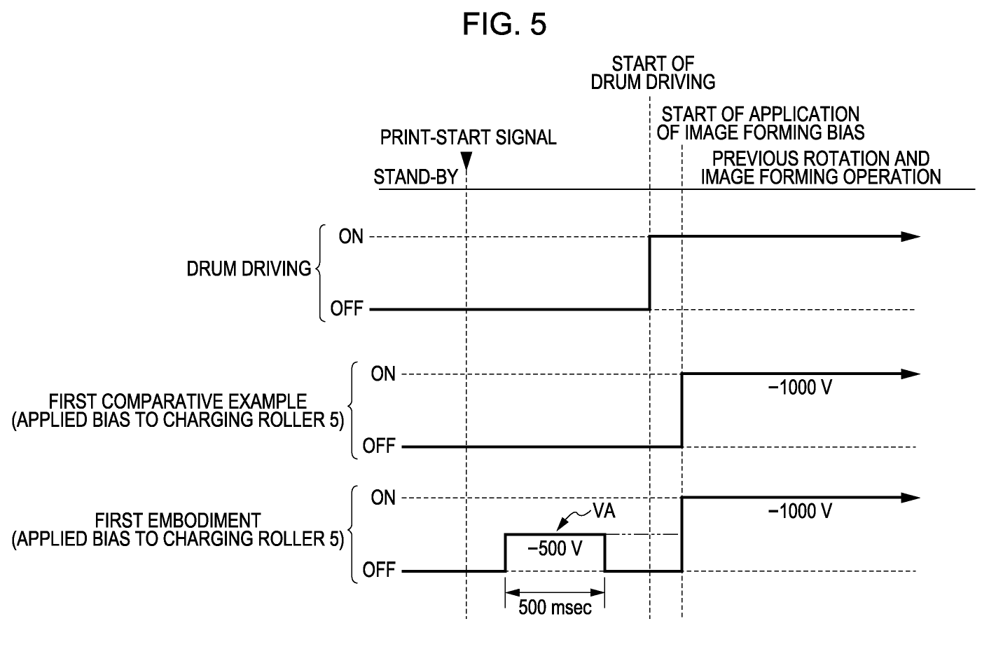

The results of a study made to determine an advantage on the occurrence of unnecessary transverse lines in an image in the first comparative example and the first embodiment are shown in Table 1. FIG. 5 illustrates a sequence chart of the bias VA before the driving of the drum starts in the first comparative example and the first embodiment. Hereinafter, the time of application of the bias VA is defined as a period of time of applying the bias to the charging roller 5 within a period of time from when a print start signal Sis input into the control circuit 100 to when the drive motor M is activated in response to the print start signal S and the driving of the drum 4 starts.

A method for determining the level of the occurrence of unnecessary transverse lines in an image is described below. First, the driving of the drum is inactive for approximately 120 minutes for each of the number of sheets of image forming (the number of sheets of continuous image forming) shown in Table 1. After that, an image forming operation is carried out, and the occurrence of transverse lines is observed using a 25% density HT image at the first sheet.

TABLE 1
Advantages in first embodiment with respect to
first comparative example

| | 0 | 1,000 | 2,000 | 3,000 | 4,000 | 5,000 |
|---|---|---|---|---|---|---|
| 1st | ◯ | ◯ | ◯ | Δ | Δ | ΔX |
| Comparative | | | | | | |
| Example | | | | | | |
| 1st | ◯ | ◯ | ◯ | ◯ | ◯ | ◯ |
| Embodiment | | | | | | |

Table 1 reveals that the first embodiment can reduce the occurrence of unnecessary transverse lines in an image deteriorating with the total number of sheets more greatly than the first comparative example.

The results are obtained because toner contaminants attached to the charging roller 5 have the positive polarity. The contamination component basically derives from toner remaining after transferring and has the positive polarity. Fundamentally, during image formation, from the potential relationship between the charging bias and the surface of the drum, material deriving from toner having the negative polarity is difficult to attach. Thus, it can be considered that, as the number of sheets of image forming increases in the cartridge 3, material having the positive polarity gradually accumulates at the surface of the charging roller, and this causes the above-described adverse effect in an image.

In the present embodiment, approximately −500 V is used as a bias applied to the charging roller 5. However, any value can also be used as long as it is smaller than the starting voltage.

In the sequence chart illustrated in FIG. 5, after the charging bias of approximately −500 V is applied, the bias is temporarily turned off. Alternatively, even if the bias is an on state until the driving of the drum starts, similar advantages are obtainable.

In a second embodiment, the time of application of the bias VA varies with the accumulated time of rotation of the drum 4 written in the storage unit 33.

In the present embodiment, in the image forming apparatus according to the first embodiment, the cartridge 3 includes two cartridge components of a drum cartridge 3A and a development cartridge 3B. The drum cartridge 3A includes the drum 4, the charging roller 5, the cleaning device 7, and the storage unit 33. The development cartridge 3B includes the developing device 6. When the toner in the development cartridge 3B is consumed and the development cartridge 3B reaches its end of life earlier, the development cartridge 3B is replaced with a new one, the new development cartridge 3B is set in the apparatus main body 1A, and image forming is performed without replacement of the drum cartridge 3A. The other conditions are substantially the same as those described in the first embodiment.

Table 2 shows the results of observing advantages of a reduction in the occurrence of unnecessary transverse lines in an image according to a second comparative example, in which the time of application of the bias VA is fixed, and according to the second embodiment, in which the time of application of the bias VA varies with the accumulated time of rotation of the drum 4. In table 2, the number of sheets of image forming is the accumulated number of sheets of total image forming. In table 2, the accumulated time of rotation of the drum cartridge 3A is shown after being converted into the accumulated number of total sheets (accumulated number of sheets of total image forming). As a condition used in this study, the bias VA having approximately −500 V is applied for approximately 500 msec before the driving of the drum starts in the second comparative example. In contrast, in the second embodiment, the time of application of the bias VA varies with the accumulated time of rotation of the drum 4, as illustrated in Table 2.

In the study illustrated in Table 2, the development cartridge 3B reached its end of life when the accumulated number of sheets of total image forming is 5,000. At that time, the development cartridge 3B was replaced with a new one, the new development cartridge 3B was set in the apparatus main body 1A, and the image forming continued without replacement of the drum cartridge 3A.

A method for determining the level of the occurrence of unnecessary transverse lines in an image is described below. First, the driving of the drum is inactive for approximately 120 minutes for each of the number of sheets of image forming shown in Table 2. After that, an image forming operation is carried out, and the occurrence of transverse lines is observed using a 25% density HT image at the first sheet.

TABLE 2
Advantages in second embodiment with respect to
second comparative example

| | No. of Sheets of Image Forming | | | | | | | | | | |
|---|---|---|---|---|---|---|---|---|---|---|---|
| | 0 | 1,000 | 2,000 | 3,000 | 4,000 | 5,000 | 6,000 | 7,000 | 8,000 | 9,000 | 10,000 |
| 2nd | ◯ | ◯ | ◯ | ◯ | ◯ | ◯Δ | Δ | Δ | ΔX | X | X |
| Comparative | | | | | | | | | | | |
| Example | | | | | | | | | | | |
| 2nd | ◯ | ◯ | ◯ | ◯ | ◯ | ◯ | ◯ | ◯ | ◯ | ◯Δ | ◯Δ |
| Embodiment | | | | | | | | | | | |
| Time of | 0 | 0 | 0 | 300 | 300 | 500 | 500 | 500 | 700 | 700 | 700 |
| Application of | | | | | | | | | | | |
| Charging Bias | | | | | | | | | | | |
| (msec) | | | | | | | | | | | |

As illustrated in the second embodiment shown in Table 2, when the accumulated number of sheets of total image forming does not exceed 2,000, no unnecessary transverse line occurs in an image. Accordingly, there is no need to have a contamination returning control mode in which the time from transmission of a print signal to image formation is delayed. That is, the control circuit 100 can have a configuration in which when the accumulated number of total image forming does not reach a predetermined number, the contamination returning control mode is not executed. When the accumulated number is 8,000 or more, advantages obtained for the time of application of the bias VA according to the second comparative example are insufficient. In this case, an adverse effect occurring in an image can be reduced by extension of the time of application of the bias VA.

As described above, with the present embodiment, changing the time of application of the bias VA in accordance with the accumulated time of rotation of the drum can ensure compatibility between an adjustment of the time from transmission of a print signal to image forming and a reduction in the level of the occurrence of an adverse effect in an image.

In the study shown in Table 2, the time of application of the bias VA is approximately 700 msec when the accumulated time of rotation of the drum 4 corresponds to 10,000 sheets of the accumulated number of sheets of total image forming. However, the time of application of the bias VA can also be another time as long as the time achieves advantages.

In a third embodiment, the time of application of the bias VA varies with the time of making the driving of the drum 4 inactive (referred to also as drum driving stop time) stored in the control circuit 100. In the present embodiment, the same image forming apparatus as in the second embodiment is used.

The present embodiment responds to a result of an experiment in which the amount of toner transferred from the charging roller 5 to the drum 4 increases with an increase in the time from the completion of previous image formation to the start of next drum driving.

Table 3 shows the results of observing advantages of a reduction in the occurrence of unnecessary transverse lines in an image according to a third comparative example, in which the time of application of the bias VA is fixed, and according to the third embodiment, in which the time of application of the bias VA varies with the time of making the driving of the drum 4 inactive.

As a condition used in this study, both of the third comparative example and the third embodiment use the cartridge 3 having an accumulated time of rotation of the drum corresponding to 8,000 sheets shown in Table 2 for the second embodiment. In the third comparative example, before the driving of the drum starts, the bias VA of approximately −500 V was applied for approximately 500 msec. In contrast, as illustrated in Table 3, the time of application of the bias VA varies with the time from the completion of image formation to the start of next drum driving. A method for determining the level of the occurrence of unnecessary transverse lines in an image is described below. First, the driving of the drum 4 is inactive for a period of time illustrated in Table 3, and then, the occurrence of transverse lines is observed using a 25% density HT image at the first sheet.

TABLE 3
Advantages in third embodiment with respect to
third comparative example

| | Time of Making Driving of | | | | | | | |
|---|---|---|---|---|---|---|---|---|
| | Photosensitive Drum Inactive (min) | | | | | | | |
| | 5 | 10 | 20 | 40 | 60 | 100 | 120 | 160 |
| 3rd | ◯ | ◯ | ◯ | ◯ | ◯ | Δ | ΔX | ΔX |
| Comparative | | | | | | | | |
| Example | | | | | | | | |
| 3rd | ◯ | ◯ | ◯ | ◯ | ◯ | ◯ | ◯ | ◯ |
| Embodiment | | | | | | | | |
| Time of | 0 | 100 | 200 | 400 | 500 | 650 | 700 | 700 |
| Application of | | | | | | | | |
| Charging Bias | | | | | | | | |
| (msec) | | | | | | | | |

As illustrated in Table 3, when the time of making the driving of the drum 4 inactive is five minutes, no unnecessary transverse line occurs in an image. Accordingly, there is no need to have a contamination returning control mode in which the time from transmission of a print signal to image formation is delayed. That is, the control circuit 100 can have a configuration in which when the time of making the driving of the drum 4 inactive is within a predetermined period of time, the contamination returning control mode is not executed. Because, after that, the amount of toner contamination transferred from the charging roller 5 to the drum 4 increases, the time of application of the bias VA increases with an increase in the time of making the driving of the drum 4 inactive. In the image forming apparatus according to the present embodiment, the amount of toner contamination transferred maxes out when the time of application of the bias VA is on the order of approximately 120 minutes. Accordingly, there is no need to further increase the time of application of the bias VA after that.

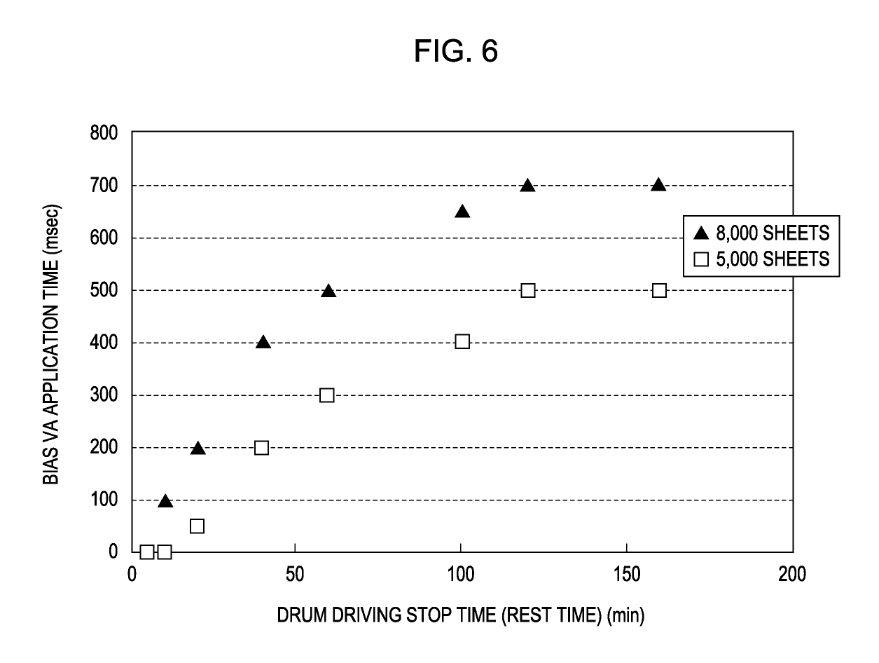

FIG. 6 plots the times of application of the bias VA having advantages of a reduction in the occurrence of unnecessary transverse lines under the same condition as in Table 3 when the accumulated time of rotation of the drum 4 corresponds to 5,000 sheets as the accumulated number of sheets of total image forming and when it corresponds to 8,000 sheets. As is clear from FIG. 6, determining the time of application of the bias VA on the basis of the accumulated time of rotation of the drum 4 stored in the storage unit 33 and the time of making of the driving of the drum inactive is more effective.

As described above, with the present embodiment, changing the time of application of the bias VA in accordance with the time of making the driving of the drum 4 inactive can ensure compatibility between an adjustment of the time from transmission of a print signal to image forming and a reduction in the level of the occurrence of an adverse effect in an image.

In the embodiments, it is assumed that the starting voltage being the upper limit is an invariable physical quantity even if the specifications of the drum or those of the charging roller are different. In contrast, with respect to the lower limit of the bias VA, of course, 0 V produces no advantages, and it has been found from an experiment that −200 V and below reliably have advantages. This value is considered as the one generally applicable in an image forming apparatus that forms a potential in an image bearing member using discharging. This is because the bias applied between the charging member and the image bearing member is not substantially changed by the specifications of both of them, and additionally, the amount of charges on the attached substances does not substantially vary in a case where the present invention is applied.

In the description of the above embodiments, the charging roller 5 is rotated so as to follow the drum 4 by a friction force received by the contact portion with the drum 4. However, other configurations may also be used. For example, the charging roller 5 may receive a force from the driving source of the drum 4 and be rotated such that no peripheral speed difference is present at the contact portion between the drum 4 and the charging roller 5.

The present invention is also applicable to a case where the charging roller 5 receives a force from a different driving source from the driving source of the drum 4 and rotate such that a peripheral speed difference is present at the contact portion between the charging roller 5 and the drum 4. In this case, before rotation of the charging roller 5 or rotation of the drum 4 starts, the bias VA is applied to the charging roller 5. This produces substantially the same advantages as in the above embodiments.

In the third embodiment, the time of application of the bias VA varies with the time of making the driving of the drum 4 inactive. Alternatively, control in which the time of application of the bias VA varies with the time of making the driving of the charging roller 5 inactive may also be performed.

1) The control circuit 100 can have a configuration in which, at power-up in the image forming apparatus, the contamination returning control mode is executed before the drum 4 is rotated by the drive motor M activated after the power is turned on.

2) In an image forming apparatus in which the drum 4 is charged by application of a charging bias having positive polarity to the charging roller 5, the contamination returning bias VA has the same positive polarity as that of that charging bias.

3) The image forming apparatus according to each of the above embodiments has a configuration in which a toner image on the drum 4 is directly transferred to a recording medium P. However, the image forming apparatus can also have an intermediate transfer configuration in which a toner image on the drum 4 is temporarily transferred to an intermediate transfer member, and it is then transferred to a recording medium P.

4) The image forming apparatus can also have a system that does not use an attachable/detachable cartridge.

5) The developing system may also be the normal development system.

6) The image forming apparatus may also use an electrostatic recording image forming process. In this case, the image bearing member is an electrostatic recording dielectric, and the information writing unit can be a charge eliminating unit, such as a charge eliminating needle array or an electron gun. The charges of a uniform charged surface of the electrostatic recording dielectric are selectively eliminated, and an electrostatic latent image is written and formed.

7) The image forming apparatus is not limited to a monochrome printing image forming apparatus. An in-line (tandem) color image forming apparatus can also be used that includes four cartridges having the above-described configuration or image forming portions, the cartridges or image forming portions holding yellow, magenta, cyan, and black colors of toner, respectively. Also with this image forming apparatus, the performance of control described in at least one of the above-described embodiments can offer substantially the same operational advantages. In the above-described embodiments, the charging roller 5 is in contact with only the drum 4 and not in contact with a contact member for cleaning the surface of the charging roller 5 (cleaning unit). The present invention is effective especially in an apparatus that does not include such a cleaning unit for cleaning the charging roller 5. However, even when such a cleaning unit for cleaning the charging roller 5 is included, if a possibility of an adverse effect on an image resulting from contamination of the charging roller 5 is present, advantages of the present invention are also obtainable.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application Nos. 2008-221133 filed Aug. 29, 2008, and 2009-158617 filed Jul. 3, 2009, which are hereby incorporated by reference herein in their entirety.

What is claimed is:

1. An image forming apparatus comprising:
a rotatable image bearing member on which a toner image is capable of being formed;
a charging roller rotatable in contact with the image bearing member; and
a controller configured to control a voltage applied to the charging roller,
wherein the controller is capable of applying a control bias to between the charging roller and the image bearing member before rotation of the image bearing member and the charging roller starts, the control bias having the same polarity as that of a bias applied in image forming.

2. The image forming apparatus according to claim 1, wherein the charging roller is rotated so as to follow rotation of the image bearing member being driven.

3. The image forming apparatus according to claim 1, wherein the charging roller rotates with a peripheral speed difference with respect to the image bearing member in response to a drive.

4. The image forming apparatus according to claim 1, wherein the control bias is smaller than a discharge starting voltage.

5. The image forming apparatus according to claim 1, wherein the control bias having an absolute value being equal to or larger than 200 volts.

6. The image forming apparatus according to claim 1, wherein time of application of the control bias increases in accordance with a number of sheets of image forming or an accumulated time of rotation of the image bearing member.

7. The image forming apparatus according to claim 1, wherein time of application of the control bias increases in accordance with time of making driving of the image bearing member or the charging roller inactive.

8. The image forming apparatus according to claim 1, wherein the controller does not apply the control bias when an accumulated number of sheets of total image forming does not reach a predetermined number or when time of making driving of the image bearing member or the charging roller inactive is within a predetermined period of time.

9. The image forming apparatus according to claim 1, wherein the charging roller is in contact with only the image bearing member.

10. An image forming apparatus comprising:
a rotatable image bearing member on which a toner image is capable of being formed;
a charging roller rotatable in contact with the image bearing member; and
a controller configured to apply a voltage to the charging roller such that unevenness of toner contamination on the charging roller is reduced before applying an image forming bias.
